(19) United States
(12) Patent Application Publication
(10) Pub. No.: US 2025/0351909 A1
(43) Pub. Date: Nov. 20, 2025

(54) MILITARY SUIT CAMOUFLAGE PATTERN FORMING METHOD

(71) Applicant: MIN JAE KIM, Gyeonggi-do (KR)

(72) Inventor: MIN JAE KIM, Gyeonggi-do (KR)

(21) Appl. No.: 19/197,041

(22) Filed: May 2, 2025

(30) Foreign Application Priority Data
May 16, 2024 (KR) 10-2024-0064031

(51) Int. Cl. A41H 3/00; A41D 29/00; G06T 7/90; G06T 11/00

(52) U.S. Cl. CPC A41H 3/007; A41D 29/00; G06T 7/90; G06T 11/001; G06T 2207/10024; G06T 2207/10032

(57) ABSTRACT

A military suit camouflage pattern forming method includes extracting, from a database storing satellite images of the earth's surface, zonal and seasonal color images captured from above a target area where military operations are expected, and generating a sample image of the ground surface using the color images, generating a dot image by mapping all pixels of the sample image to a smaller number of pixels, and extracting different camouflage colors from the pixels of the dot image, by reclassifying the sample image based on the elevation and slope of the ground surface and converting it to grayscale, extract different terrain patterns based on elevation and slope, as primary patterns, and coloring the primary patterns with the extracted camouflage colors to generate secondary patterns in which colors vary according to the terrain patterns, and superimposing the secondary patterns over a background color to generate a camouflage pattern.

### CROSS REFERENCE TO RELATED APPLICATIONS AND CLAIM OF PRIORITY

This application claims the benefit under 35 USC § 119 of Korean Patent Application No. 10-2024-0064031 filed on May 16, 2024 in the Korean Intellectual Property Office. The disclosures of the priority applications are hereby incorporated by reference in their entireties.

### BACKGROUND

### 1. Field of the Invention

The present invention relates to a military suit camouflage pattern forming method, and more particularly, to a military suit camouflage pattern forming method that exhibit excellent camouflage and concealment effects in operational areas.

### 2. Description of the Related Art

Although decades have passed since the end of the Cold War, wars continue to persist. Localized conflicts and provocations are repeatedly occurring in border areas of various countries, including conflict zones in Israel, and civil wars in weakly governed or newly established third-world countries have not ceased. the Russia-Ukraine war has also continued for several years.

As such, given the ongoing wars, civil conflicts, and military tensions in many countries, strengthening national military power is becoming an unavoidable trend even from a defensive standpoint. In modern warfare, while the performance of weapons plays a role, the operation of military personnel is also crucial, particularly in localized warfare, making qualitative improvement of military personnel important.

Qualitative improvement of military personnel can include enhancement of equipment and firepower, increased combat capabilities, and improved survivability. In particular, military suits are essential equipment directly related to the protection and survival of personnel, and various improvements have been attempted. For example, improvements through changes in structure or materials of military suits are known (e.g., Korean Patent No. 10-2471760).

However, improvements in the camouflage and concealment capabilities of military suits, which enable effective and proactive personnel operations in combat zones, are still insufficient. Camouflage patterns on military suits enable close military operations and disrupt enemies while enhancing individual survivability, but conventional methods have not been satisfactory, prompting demand for improvement.

### SUMMARY

The technical problem to be solved by the present invention is to provide a military suit camouflage pattern forming method that demonstrate excellent camouflage and concealment effects in operational areas, thereby enhancing operational effectiveness, personnel protection, and overall combat capability in such regions.

The technical problem of the present invention is not limited to the aforementioned and other problems not mentioned will be clearly understood by those skilled in the art from the following description.

Means for Solving the Problem the military suit camouflage pattern forming method according to the present invention comprises: (a) extracting, from a database storing satellite images of the surface of the earth, zonal and seasonal color images captured from above a target area where military operations are expected, and generating a sample image of the ground surface of the target area from the color images; (b) generating a dot image by mapping all pixels of the sample image to a smaller number of pixels than the original, and extracting different camouflage colors from the pixels of the dot image; (c) by reclassifying the sample image based on the elevation and slope of the ground surface and converting it to grayscale, extracting different terrain patterns based on the elevation and slope, as primary patterns; and (d) coloring the primary patterns with the camouflage colors to generate secondary patterns whose colors vary according to the terrain patterns, and superimposing a plurality of the secondary patterns over a background color to generate a camouflage pattern.

In step (b), the camouflage colors may be extracted in the order of highest ratio among the colors repeatedly appearing in the pixels of the dot image.

In step (c), the primary pattern may be extracted as a number of shaded (grayscale) images equal to the number of camouflage colors extracted in step (b).

In step (c), the primary pattern may be extracted through a highlighting process that amplifies the contrast of the terrain pattern after grayscale conversion.

At least a portion of the terrain pattern in step (c) may include a fractal pattern having self-similarity in at least a part of the whole and the detail.

The primary pattern in step (c) may have different areas according to the elevation and slope of the ground surface, in proportion to the magnitude of shading that varies depending on the terrain pattern.

In step (d), the coloring may be performed by matching camouflage colors with relatively high occurrence ratios in the dot image to the primary patterns with relatively smaller areas.

In step (a), the seasonal color images may be extracted excluding winter images of the target area.

The method may further comprise, after step (d), adding an encrypted anti-forgery pattern superimposed on the camouflage pattern.

The camouflage pattern may have a resolution of 50 pixels per inch or more and less than 100 pixels per inch.

Effects of the Invention According to the present invention, more effective personnel camouflage and concealment can be achieved in areas where combat is expected. Since the camouflage pattern accurately and effectively reflects the ground environment of the target area, high-level concealment becomes possible, allowing for more active, close, and effective personnel movement.

Moreover, the invention can be universally applied to one or more expected combat areas, thereby enhancing military operational effectiveness in various regions experiencing ongoing tension, and improving individual survivability through excellent camouflage and concealment, leading to practical reinforcement of personnel.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a conceptual diagram of a system capable of performing the military suit camouflage pattern forming method of the present invention.

FIG. 2 is an example of a sample image of the ground surface of a target area.

FIG. 3 is an example diagram showing the method of generating a dot image from a sample image and the extracted camouflage colors.

FIG. 4 is a diagram illustrating a method of extracting camouflage colors from multiple sample images.

FIG. 5 is a diagram illustrating an example of color combination using the extracted camouflage colors.

FIGS. 6A to 6F are diagrams showing classification of sample images based on elevation and slope.

FIG. 7 is an example of primary patterns extracted from each classified sample image of FIGS. 6A to 6F.

FIG. 8 is a detailed view of the primary pattern extraction process shown in FIG. 7.

FIG. 9 is an example of secondary patterns generated by combining extracted primary patterns and camouflage colors.

FIG. 10 is an example of different secondary patterns generated for each primary pattern in FIG. 7.

FIG. 11 is an example of a camouflage pattern generated by combining multiple secondary patterns and background colors.

FIG. 12 is an example showing the application of the camouflage pattern and an anti-counterfeit pattern to a military suit.

FIG. 13 is a flowchart illustrating the military suit camouflage pattern forming method according to the present invention.

### DETAILED DESCRIPTION

The advantages and characteristics of the present invention and the methods for achieving them will become apparent from the following detailed description of the embodiments with reference to the accompanying drawings. However, the present invention is not limited to the embodiments disclosed below and may be implemented in various other forms. The embodiments are merely provided to complete the disclosure of the present invention and to fully convey the scope of the invention to those skilled in the art. Throughout the specification, identical reference numerals denote identical components.

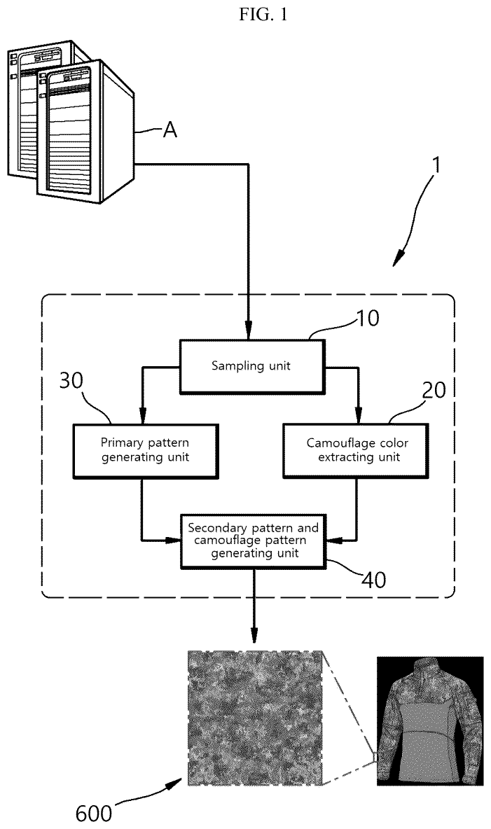

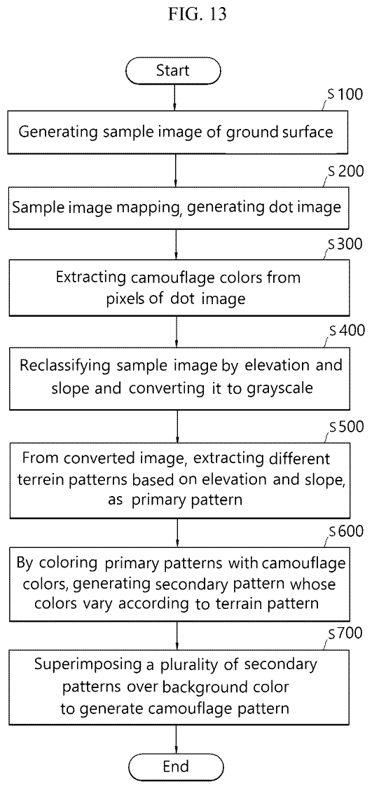

Hereinafter, a detailed description of the military suit camouflage pattern forming method according to the present invention will be provided with reference to FIGS. 1 to 13. The method description is based on the flowchart of FIG. 13 and may refer to other drawings as necessary.

FIG. 1 is a conceptual diagram of a system capable of performing the military suit camouflage pattern forming method of the present invention, and FIG. 13 is a flowchart illustrating the military suit camouflage pattern forming method according to the present invention.

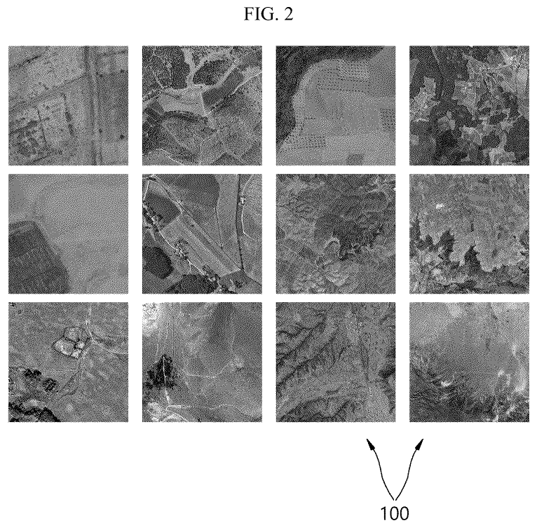

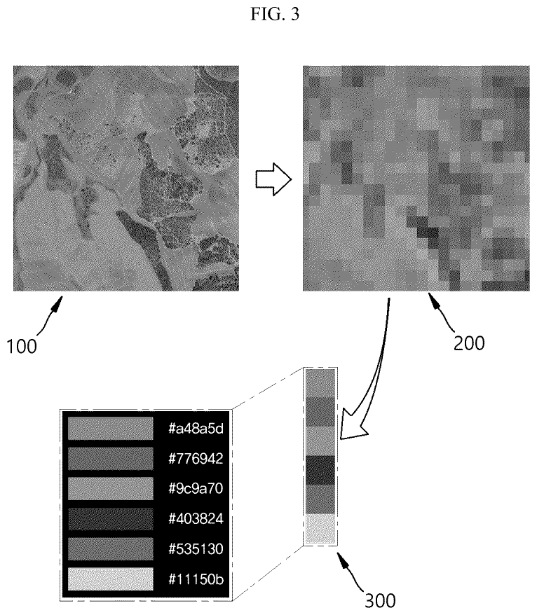

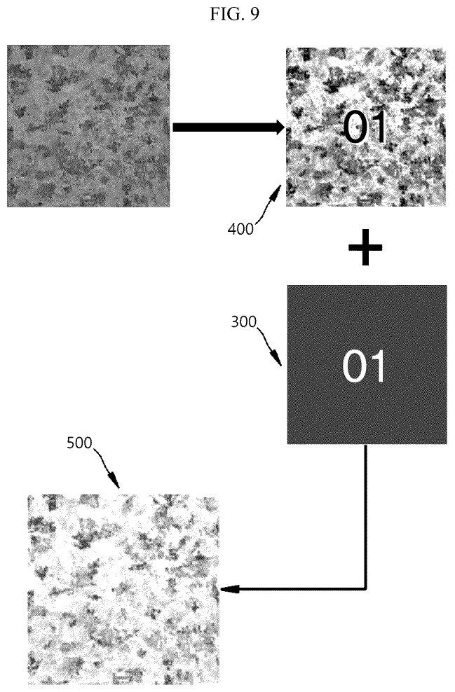

Referring to FIG. 1, the military suit camouflage pattern forming method (hereinafter, the “camouflage pattern forming method”) according to the present invention includes steps (see FIG. 13, steps S100 to S700) for obtaining surface images of a target area (i.e., an area where military operations are currently or potentially expected) from a database (A), and generating various analytical images (see FIG. 2: 100; FIGS. 3: 200 and 300; FIGS. 9: 400 and 500). These analytical images are processed to effectively reveal the vegetation, seasons, surface location (e.g., latitude), elevation, and terrain slope patterns of the target area (expected operation zone).

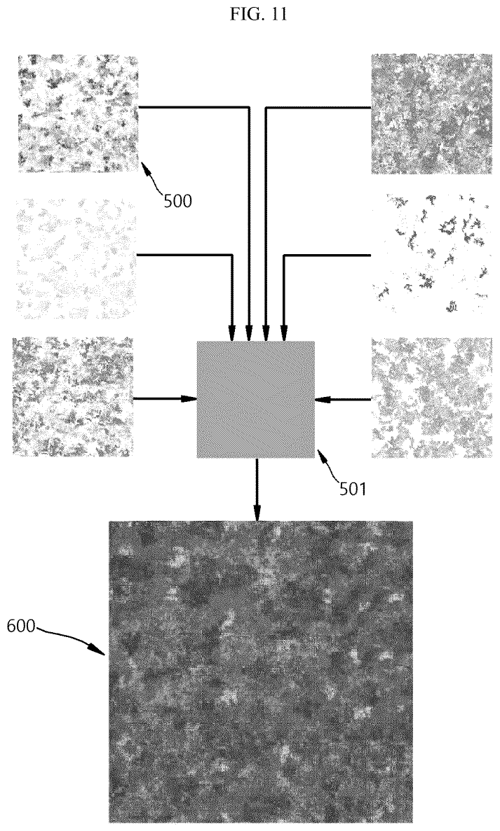

The present invention combines the generated analytical images—including the sample image, the dot image, camouflage colors extracted therefrom, the primary pattern containing terrain information, and the secondary pattern created by coloring the primary pattern with the camouflage colors—in an extremely organic manner to generate a camouflage pattern (see FIG. 11: 600) that is visually very difficult to distinguish in the target area. Therefore, highly improved camouflage and concealment effects can be achieved in the target area. The camouflage pattern may be generated by taking into consideration one or more target areas, allowing the resulting camouflage pattern to be universally applicable to two or more different expected operational zones.

While the camouflage pattern is exemplified as being applied to a military suit, it is not necessarily limited thereto. That is, the camouflage pattern of the present invention may also be applied to other military equipment requiring camouflage and concealment, and thus can be used across military supplies or in other corresponding fields requiring similar camouflage and concealment effects.

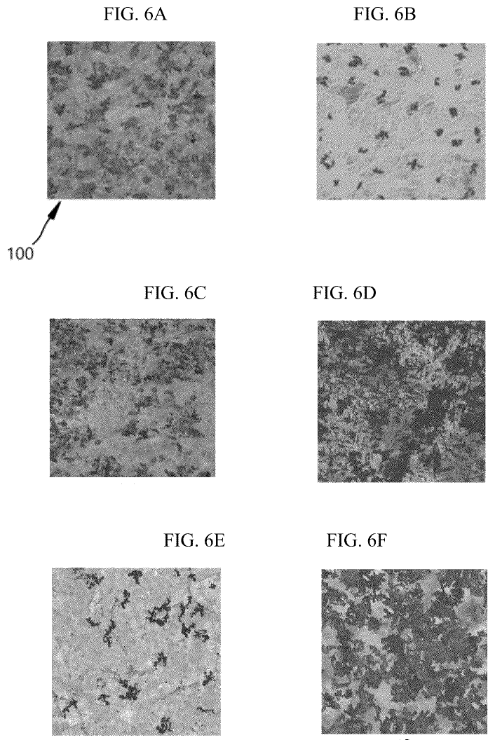

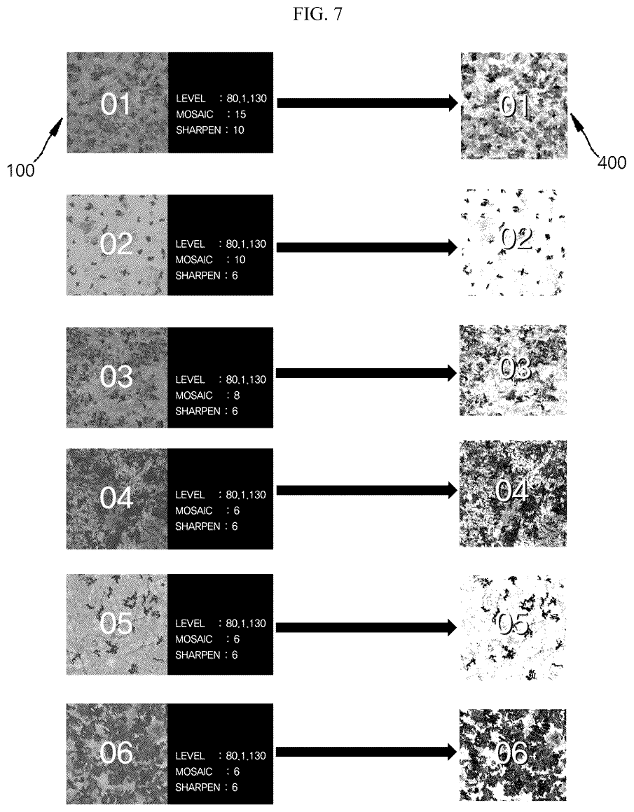

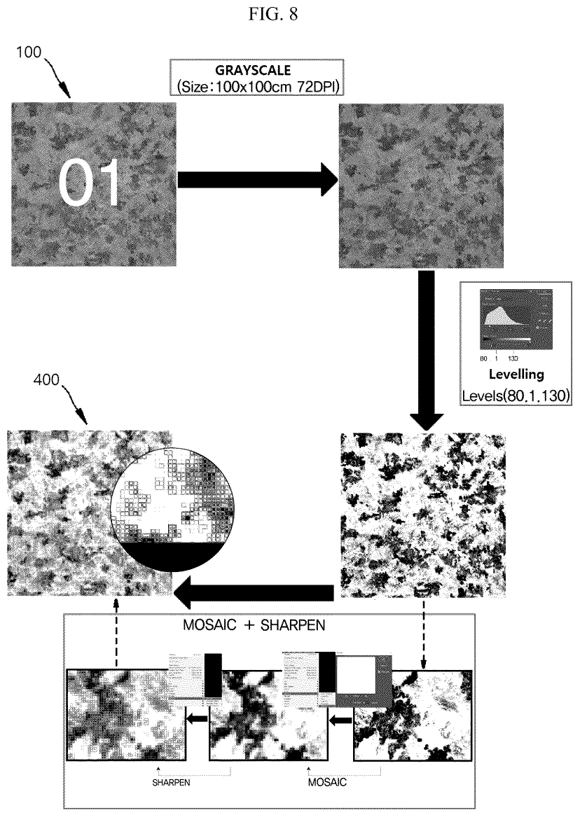

The camouflage pattern forming method of the present invention comprises the following steps. Referring to the flowchart of FIG. 13, the method includes:
(a) extracting, from a database (A) storing satellite images of the surface of the earth, zonal and seasonal color images captured from above a target area where military operations are expected, and generating a sample image (see FIG. 2: 100) of the ground surface of the target area from the color images (step S100);
(b) generating a dot image (see FIG. 3: 200) by mapping all pixels of the sample image to a smaller number of pixels than the original, and extracting different camouflage colors (see FIG. 3: 300) from the pixels of the dot image (steps S200 and S300);
(c) by reclassifying the sample image based on the elevation and slope of the ground surface (see FIGS. 6A to 6F) and converting it to grayscale, extracting different terrain patterns based on the elevation and slope, as primary patterns (see FIGS. 7 and 8: 400) (steps S400 and S500); and
(d) coloring the primary pattern with the camouflage colors to generate a secondary pattern (see FIG. 9: 500) whose color varies according to the terrain pattern, and superimposing a plurality of the secondary patterns over a background color to generate a camouflage pattern (see FIG. 11: 600) (steps S600 and S700).

In other words, the present invention includes a process of simplifying surface images of a target area into a dot form, and compressively extracting key zonal and seasonal colors of the target area from selected dots (or simplified pixels), as camouflage colors. By applying the extracted camouflage colors, a camouflage pattern can be generated that naturally blends into the target area.

Furthermore, the pattern combined with the camouflage colors also reflects the terrain of the target area that varies with elevation and slope. That is, the pattern of the camouflage pattern itself reflects the terrain characteristics of the target area, thereby enabling the generation of an effective camouflage pattern that is very difficult to visually distinguish in the target area. For example, by mimicking the terrain pattern of the target area, the camouflage pattern can also provide camouflage and concealment effects based on natural fractal effects (e.g., self-similarity between the whole and parts such that the overall pattern is repeated even in the details). In addition, as will be described below, various technical features are employed to generate the camouflage pattern, further enhancing its camouflage and concealment effects.

Hereinafter, a more detailed description of the camouflage pattern forming method according to the present invention will be provided based on specific embodiments.

The camouflage pattern forming method of the present invention is characterized by utilizing surface images of a target area and can be implemented using a computer system and/or computer graphics system capable of image processing. In order to enable a clearer understanding of the invention, a brief explanation of the system capable of executing the invention will be provided first, followed by a more detailed description of the camouflage pattern forming method of the invention.

FIG. 1 illustrates an example of a camouflage pattern forming system (1). Referring to FIG. 1, the camouflage pattern forming system may be connected to a database (A) in which ground surface images are stored. The database (A) may be a local data storage connected locally to the system or may be a remote server connected via the internet. That is, the database (A) is not limited as long as it can provide satellite images and/or aerial photographs of the ground surface. For example, the database (A) may include servers of companies that provide ground images over the internet (e.g., Google Earth), and it may also include other servers capable of providing satellite and/or aerial images.

In the present invention, the surface image refers broadly to an image of the ground captured from above the target area, and thus should be interpreted to include satellite and/or aerial photographs.

The camouflage pattern forming system (1) may include, for example, a sampling unit (10), a camouflage color extracting unit (20), a primary pattern generating unit (30), and a secondary pattern and camouflage pattern generating unit (40). These components are functionally distinguished and therefore may not necessarily correspond to the hardware or software configuration of the system. For instance, each component may be distributed across one or more software programs on different servers on the internet. The illustrated components may be used to perform the image processing described in the following steps and may include one or more image processing programs for that purpose. Additionally, each component may include one or more computer hardware units capable of loading such programs, if necessary. For example, the camouflage pattern forming system (1) may be installed on computer hardware that includes one or more programs capable of image processing. The computer hardware may be a single device or may comprise two or more hardware devices configured in parallel.

For instance, the sampling unit (10) may be configured to search, select, combine, and extract color images from the database (A). When the database (A) is a server on the internet, the sampling unit (10) may also be capable of accessing the server. The sampling unit (10) may store the extracted images in memory, which may be shared within the system. Alternatively, memory for storing images may be formed in each component, allowing for transmission and exchange of images between components. The sampling unit (10) is not limited in its function or configuration, as long as it is capable of implementing the processing of each step described below.

The camouflage color extracting unit (20) may broadly have various image transformation and image processing functions including mapping of the extracted sample image. The camouflage color extracting unit (20) may include pixel-level processing capabilities such as analyzing pixel distribution, color ratios, distinguishing and identifying colors, and performing transformations. The camouflage color extracting unit (20) is also not limited in its function or configuration, as long as it is capable of implementing the processing of each step described below.

The primary pattern generating unit (30) may broadly have functions including image transformation with grayscale conversion, highlighting, and pattern extraction through such processes. The primary pattern generating unit (30) may be configured to distinguish and classify images based on elevation and slope by transforming the sample image and comparing shading. It may also be capable of classifying, identifying, combining, and enhancing terrain patterns. Additionally, the unit may be formed to perform other processing such as mosaic effects through pixel merging, resizing, and cell transformation, or edge or boundary enhancement through sharpening. The primary pattern generating unit (30) is also not limited in its function or configuration, as long as it is capable of implementing the processing of each step described below.

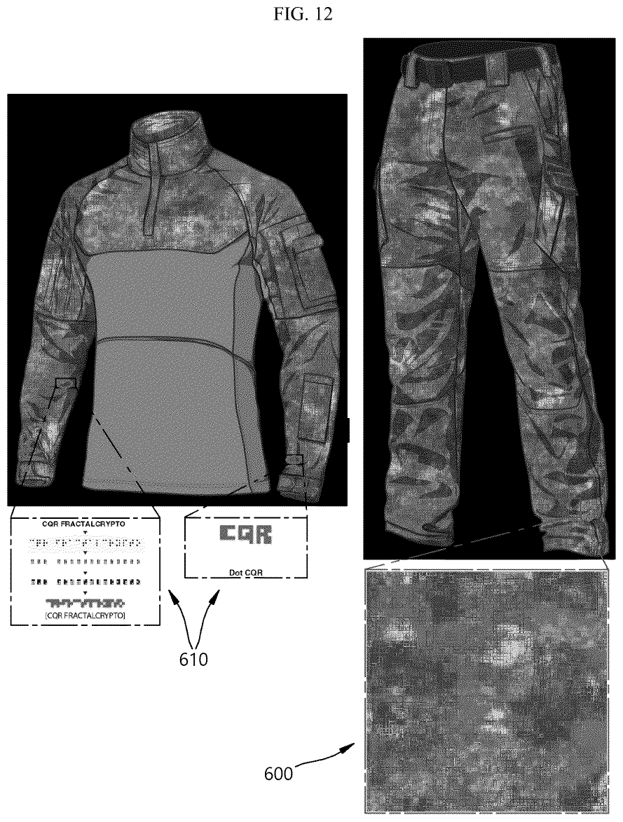

The secondary pattern and camouflage pattern generating unit (40) may broadly have various image transformation and enhancement functions including pattern extraction within an image, coloring, and color transformation of the pattern by coloring. Particularly, the secondary pattern and camouflage pattern generating unit (40) may have functions such as overlapping multiple patterns and/or images to form multilayer layers and combining such layers by copying, overlapping, and integrating images. Furthermore, if necessary, it may be capable of generating and adding specific patterns such as the encrypted anti-forgery pattern (see FIG. 12: 610) described below to the camouflage pattern. The secondary pattern and camouflage pattern generating unit (40) is also not limited in its function or configuration, as long as it is capable of implementing the processing of each step described below.

This system configuration is merely exemplary and not limiting, and may be modified as necessary. Although the configuration of the system is described in a segmented manner for illustrative purposes, if the functions or processing of the illustrated components can be implemented in a single program, two or more components may be integrated into one program. In other words, this embodiment should be understood as illustrative and may be modified in various ways within the scope in which the camouflage pattern forming method described below can be implemented.

Hereinafter, based on such a system, the camouflage pattern forming method of the present invention will be described in further detail with reference to the accompanying drawings.

The camouflage pattern forming method will be described with reference to the flowchart shown in FIG. 13, along with other drawings when necessary. The specific method is as follows.

FIG. 2 is an example of a sample image of the ground surface of a target area.

First, zonal and seasonal color images captured from above a target area where military operations are expected are extracted from a database storing satellite images of the ground surface (see FIG. 1: A), and a sample image (100) of the ground surface of the target area is generated from the extracted color images (step S100) [step (a)]. This step may be performed by the aforementioned sampling unit.

Referring to FIG. 2, the sample image (100) can be extracted from the database storing satellite images of the ground surface as described above. If the database is located on a remote server, the image may be retrieved and downloaded while connected to the server. The database (A) may include aerial photographs in addition to satellite images, and the images may be continuously updated. Therefore, the most recently updated images may be used during the image extraction process. While the sample image (100) is illustrated as a satellite image, aerial photographs may also be used, and are not excluded.

The target area (expected operation zone) requiring sample image generation may include one or more areas considered together. For example, given that various conflict zones (e.g., Ukraine, Israel, Syria, Iraq, China, the Crimean Peninsula, etc.) are concentrated between latitudes 30 to 50 degrees north in the Northern Hemisphere, one or more countries, parts of countries, or border regions between two countries within that range may be selected as the target area (expected operation zone). The target area may be changed as needed.

The sample image (100) may be formed as a color image of the ground surface of the target area captured from above, as shown in FIG. 2. In particular, multiple zonal and seasonal color images of the target area may be extracted and combined to generate the sample image (100). For example, the sample image (100) may be extracted by selecting appropriate elevations for one or more target areas and dividing the region into segments. Various zonal and seasonal differences may be reflected in the surface color images, and these may be extracted as sample images (100). An example of such a sample image (100) of the target area is shown in FIG. 2.

In the example of FIG. 2, the sample image (100) may be selected from color images of a target area captured at an altitude (camera height) of 3000-4000 meters, with a scale of 5 cm: 100-200 meters, and may be extracted from 50-100 different zones. The target area (i.e., the expected operation zone) from which such color images are extracted may be an area where combat is anticipated among countries experiencing conflict or tension between latitudes 30-50 degrees north, as mentioned above. FIG. 2 shows only a portion of such extracted sample images (100), and the total number of sample images may be significantly greater (e.g., 60-100 or more, or as many as possible within feasible limits).

In this step (step (a), i.e., the sample image generation step), it is preferable to exclude winter images of the target area when extracting seasonal color images. That is, spring, summer, and autumn color images, which share overlapping color ranges due to vegetation and the like, may be extracted and used as the sample image (100). This may also take into account the increased tactical activity during these seasons. For example, the sample image (100) may be mainly extracted from spring and autumn, and summer images with distinct color differences may be excluded. Likewise, in the camouflage color extraction step described later, colors with significant differences (e.g., vivid blue colors of midsummer) may also be excluded. On the other hand, since winter seasonal colors are markedly different from those of other seasons, a separate camouflage pattern may be formed for winter if necessary. In this way, the ground surface image of the target area may be extracted and used as the sample image (100).

FIG. 3 is an example diagram showing the method of generating a dot image from a sample image and the extracted camouflage colors.

Subsequently, as shown in FIG. 3, all pixels of the extracted sample image (100) are mapped to a smaller number of pixels than the original to generate a dot image (200), and different camouflage colors (300) are extracted from the pixels of the dot image (steps S200 and S300) [step (b)]. This step may be performed by the aforementioned camouflage color extracting unit.

The camouflage colors (300) may be extracted through the simplification process of the sample image (100). That is, the sample image can be simplified into the dot image (200) through a simplified image conversion in which two or more original pixels (pixels of the sample image) are mapped to a single pixel (pixel of the dot image), rather than one-to-one mapping. In this process, the shape (or pattern) of the sample image (100) is simplified, but the pixels of the dot image (200), which express the shape, are regenerated by integrating the colors of two or more pixels dispersed in the sample image (100), thereby compressively representing the color of the original image. That is, as shown in FIG. 3, the color information of the sample image (100) can be compressively expressed in each pixel of the dot image (200) through a mapping method that reduces the number of pixels compared to the original. Different camouflage colors (300) can then be extracted from the pixels of the generated dot image (200).

In FIG. 3, a plurality of camouflage colors (300) extracted with different color numbers are illustrated. These camouflage colors (300) are extracted from the pixels of the dot image (200) (e.g., it can be 20 pixels each in width and height), allowing the color of the sample image (100) to be represented even with a small number of colors. Therefore, the camouflage colors (300) extracted from the pixels of the dot image (200) can more efficiently reflect the regional and seasonal colors of the target area. As shown in FIG. 3, multiple camouflage colors (300) (e.g., six or more) can be extracted from the dot image (200) converted from a sample image (100) of a single region, and such extraction may be repeated for multiple regions. Accordingly, camouflage colors (300) that reflect the overall characteristics of the target area can be generated.

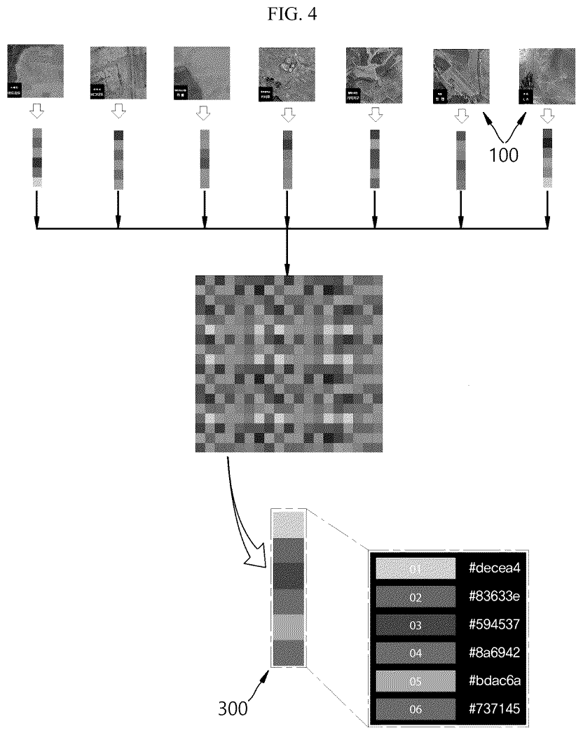

FIG. 4 is a diagram illustrating a method of extracting camouflage colors from multiple sample images.

As shown in FIG. 4, for multiple sample images (100) of different regions, image conversion (conversion to dot images) may be performed respectively to extract camouflage colors by region, and these may be collected and used to extract the final camouflage colors (300) for the entire set of different regions. For example, sample images (100) for dozens (e.g., 66 or more) of different regions within the target area may be generated, and multiple (e.g., six) camouflage colors may be extracted from each sample image. These may be combined into an expanded set of color combinations (e.g., 396 colors), from which a final set of multiple (e.g., six) camouflage colors (300) may be ultimately selected.

At this time, the camouflage colors (300) in step (b) (i.e., the camouflage color extraction step) may be extracted in order of highest frequency among the colors repeatedly appearing in the pixels of the dot image (see FIG. 3: 200), for example. That is, the camouflage colors are extracted in descending order of frequency from among the colors that are repeatedly represented in the pixels of the dot image. That is, the dot image converted from each sample image may be analyzed, and the colors appearing in each pixel may be identified in order of ratio, and then extracted in that order to more effectively determine the camouflage colors (300) of the target area. The number of camouflage colors (300) can be increased or decreased as needed and is not limited to the illustrated example. In this manner, it is possible to extract the key camouflage colors of the target area from the pixels of a simplified dot image.

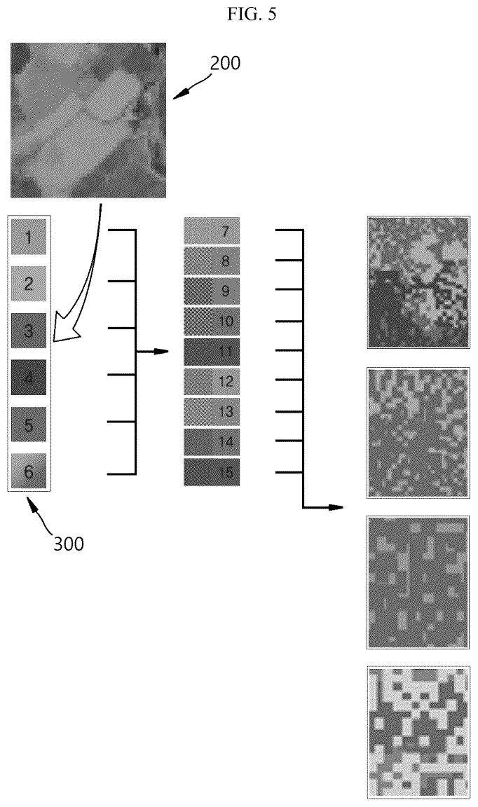

FIG. 5 is a diagram illustrating an example of color combination using the extracted camouflage colors.

The extracted camouflage colors (300) may be combined in dot units to form various colors and patterns. For example, as shown in FIG. 5, by combining the six final extracted camouflage colors (300) [refer to colors numbered 1 to 6 on the left side of FIG. 5], it is possible to generate more color variations than the initially extracted camouflage colors [refer to colors numbered 7 to 15 in the middle between the left and right in FIG. 5]. In addition, such colors may be combined in dot units to form various types of patterns [refer to patterns illustrated on the right side of FIG. 5].

In particular, the present invention generates a camouflage pattern that more effectively reflects the color and regional characteristics of the target area by combining the extracted camouflage colors (300) with terrain patterns. The terrain patterns are extracted through a separate process from the camouflage color extraction and are finally colored with the camouflage colors to generate a camouflage pattern having highly enhanced camouflage and concealment effects that are visually difficult to distinguish in the target area. A more detailed description of the terrain pattern extraction and its combination with the camouflage colors will be provided below.

FIGS. 6A to 6F are diagrams showing classification of sample images based on elevation and slope. FIG. 7 is an example of primary patterns extracted from each classified sample image of FIGS. 6A to 6F. FIG. 8 is a detailed view of the primary pattern extraction process shown in FIG. 7.

As described above, after the camouflage colors have been extracted, the sample image (100) is reclassified according to the elevation and slope of the ground surface (see FIGS. 6A to 6F), and converted to grayscale to extract terrain patterns that vary according to elevation and slope, which serve as primary patterns (400) (see FIGS. 7 and 8) (steps S400, S500) [step (c)]. This step may be performed by the aforementioned primary pattern generating unit.

FIGS. 6A to 6F illustrate examples of the classification of the sample image (100) according to elevation and slope. That is, the sample image may be used in a different manner for the extraction of camouflage colors and terrain patterns. For example, the sample image (100) may be classified by elevation and slope into terrain types such as flatland [FIG. 6A], gently undulating plain [FIG. 6B], gently sloped terrain [FIG. 6C], moderately sloped terrain [FIG. 6D], semi-steep slope [FIG. 6E], and steep slope [FIG. 6F]. Based on this classification, terrain patterns of different shapes, patterns, and areas can be extracted. These classifications are merely exemplary and may be further subdivided as necessary.

FIG. 7 shows examples of different primary patterns (400) extracted from the sample images (100) classified in FIGS. 6A to 6F. As shown in FIG. 7, each of the classified sample images (100) can be converted into grayscale (a monochrome or grayscale image that conveys only luminance information), and extracted into different primary patterns (400). The primary patterns (400) express the terrain differences caused by elevation and/or slope as variations in shading and can be extracted as diverse black-and-white patterns depending on the terrain [the numbers 01-06 in FIG. 7 correspond to the classifications in FIGS. 6A to 6F].

In other words, by converting the color photographs (sample images) into grayscale, the shading caused by differences in elevation and/or slope can be accurately extracted as a primary pattern. Therefore, various primary patterns (400) reflecting terrain characteristics of the target area-from relatively flat areas [FIG. 6A, e.g., flatlands] to areas with higher elevation and steeper slopes [FIG. 6F, e.g., steep slopes]—can be extracted. The primary pattern (400) corresponds to a black-and-white image from which color information is excluded, representing only the terrain pattern that varies according to elevation and slope in the target area.

These primary patterns (400) may be extracted as the same number of grayscale images (i.e., black-and-white images) as the number of camouflage colors finally extracted in the previous step (b) (see FIG. 7). That is, the number of extracted camouflage colors and the number of primary patterns (400) may be matched so that the camouflage colors and the primary patterns can be combined one-to-one. As previously described, in this embodiment, six final camouflage colors (see FIG. 4: 300) are illustrated, and six corresponding primary patterns (400) reflecting different elevations and slopes are shown in FIG. 7 [patterns 01-06]. However, the number of patterns may be changed as needed and should not be construed as limiting.

Referring to FIG. 8, the primary patterns (400) can be extracted through various techniques after grayscale conversion, such as highlighting to enhance the contrast of the terrain pattern (e.g., level adjustment), applying a mosaic effect to emphasize dot shapes (e.g., using pixel merging, resizing, or resolution adjustment), and applying sharpness enhancement (e.g., a sharpen filter) to emphasize the edges or borders and maximize the square dot shapes. That is, after initially removing the color information through grayscale conversion to extract terrain information, the contrast may be further enhanced to obtain a clearer and simplified terrain pattern, and additional processing—such as emphasizing and adjusting dot patterns for better visual cohesion, combination, or area balancing (e.g., mosaic followed by sharpening)—may also be applied.

Although the primary pattern (400) generation process illustrated in FIG. 8 is shown for one example (e.g., flatland) among those in FIG. 7, the other primary patterns in FIG. 7 may be extracted using the same process, and the extraction of all the primary patterns in FIG. 7 can be understood according to the process illustrated in FIG. 8.

As shown in FIG. 8, the highlighting process after grayscale conversion may utilize level adjustment functions included in image editing programs [e.g., functions that adjust black-and-white tones and highlight intensity—where numerical values may correspond to brightness, intensity, etc.]. Mosaic effects and sharpness enhancement may also utilize mosaic processing and sharpen functions included in image editing software. Through these processes, the final primary pattern (400) may be formed as illustrated, with enhanced shading (highlighting) and emphasized dot shapes (via mosaic processing and sharpening).

The primary pattern may be a black-and-white image with emphasized shading, and the dot size used in the mosaic processing may be appropriately adjusted.

Since the primary patterns (400) are generated as shaded images, they have the characteristic of possessing different areas according to the elevation and slope of the ground surface, in proportion to the size of the shading that varies by terrain pattern. In other words, for various terrains with different elevations and slopes (see terrains corresponding to FIG. 7, items 01 to 06, from flatlands to steep slopes), the area (shaded area) of the corresponding primary pattern (400) also varies accordingly. In this way, terrain patterns corresponding to elevation and slope can be extracted and expressed as shaded patterns, with their areas differentially adjusted.

These area differences among the primary patterns (400) are particularly advantageous when generating the camouflage pattern (see FIG. 11: 600) described later, as they allow the patterns to be combined to fill the entire surface without gaps. That is, relatively large-area primary patterns (400) [e.g., FIG. 7: items 04 and 06] and relatively small-area primary patterns (400) [e.g., FIG. 7: items 02 and 05] can coexist with medium-area primary patterns (400) [e.g., FIG. 7: items 01 and 03] to ensure complete coverage of a surface when overlaid on the same plane.

At this time, the size of the dots may be adjusted through mosaic processing to control the area and distribution of the primary patterns (400). For example, in the primary patterns (400) of FIG. 7 corresponding to low elevation or low slope areas [e.g., flatlands, gently undulating plains, and gently sloped terrains-items 01 to 03], the dot size may be enlarged (e.g., mosaic values 15, 10, and 8, respectively), whereas for high elevation or high slope areas [e.g., moderately sloped, semi-steep, and steep terrains-items 04 to 06], the dot size may be reduced (e.g., mosaic value 6). This enables enhanced emphasis on the shading of low elevation or low slope regions. As a result, the distribution of patterns can be made more balanced within a possible range.

In addition, as described above, the primary pattern (400) reflects the terrain pattern based on elevation and slope in the target area. Therefore, by combining these patterns, it is also possible to preserve and display information about the terrain of the target area within the camouflage pattern itself. For example, some of the terrain patterns forming the primary pattern (400) may include fractal patterns exhibiting self-similarity in at least some portions of both the whole and the detail. This allows the terrain pattern, derived from an aerial image of the target area as a whole, to aid in camouflage and concealment of individual personnel operating within the target area.

Moreover, as previously described, the camouflage colors used in the camouflage pattern are obtained by compressing the color information of the target area into single pixels. Thus, by combining the selected terrain patterns with the extracted camouflage colors, a camouflage pattern can be generated in which both terrain and color information of the target area are harmoniously reflected, thereby enabling highly effective camouflage and concealment. A detailed explanation of the generation of secondary patterns and the superposition process for generating the final camouflage pattern is provided below.

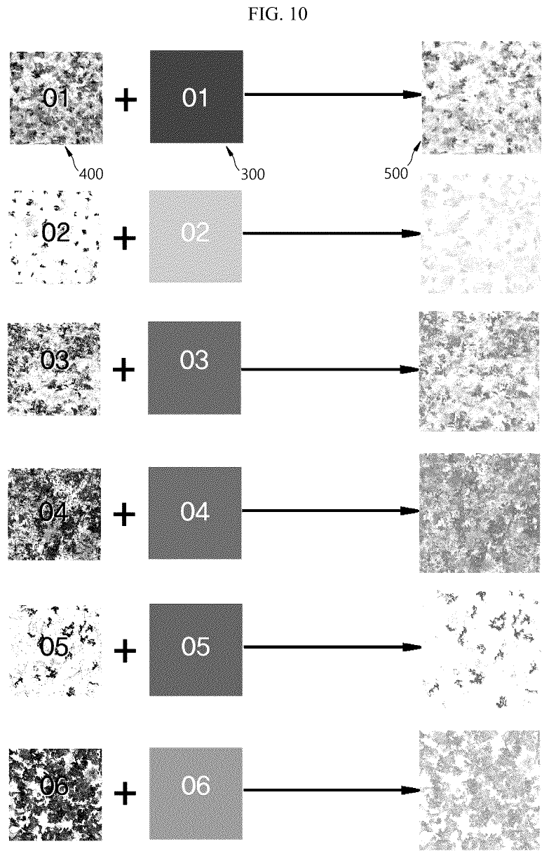

FIG. 9 is an example of secondary patterns generated by combining extracted primary patterns and camouflage colors. FIG. 10 is an example of different secondary patterns generated for each primary pattern in FIG. 7.

As described above, after generating the primary patterns, each primary pattern (400) is colored with a camouflage color (300) to generate a secondary pattern (500) in which the color varies according to the terrain pattern. A plurality of such secondary patterns (500) are then superimposed on a background color (see FIG. 11: 501) to generate the final camouflage pattern (see FIG. 11: 600) (steps S600 and S700) [step (d)]. This step may be performed by the aforementioned secondary pattern and camouflage pattern generating unit.

FIG. 9 illustrates the process of generating a secondary pattern (500) from a primary pattern (400). As shown, one primary pattern (400) may be matched with one camouflage color (300), and the entire pattern may be colored with the corresponding camouflage color (300). In this way, a plurality of secondary patterns (500) with varying colors depending on the terrain pattern can be generated. As previously mentioned, the number of primary patterns (400) matches the number of extracted camouflage colors (300), allowing one-to-one matching between the camouflage colors and primary patterns. Consequently, the same number of colored secondary patterns (500) as primary patterns (400) can be generated.

The coloring in this case may involve replacing all the pixel colors forming the primary pattern (400) with the same camouflage color (300), and various image processing techniques may be applied within this scope. By combining the primary pattern (400) with a camouflage color (300) in this way, a secondary pattern (500) in which the terrain pattern (primary pattern) is colored with the camouflage color is generated, as shown in the lower portion of FIG. 9.

As illustrated in FIG. 10, all primary patterns (400) (01 through 06) are paired one-to-one with corresponding camouflage colors (300) (01 through 06), and thus, the number of secondary patterns (500) generated is the same as the number of primary patterns. As previously described, the primary patterns (400) reflect different terrain patterns based on the elevation and slope of the target area, and the secondary patterns (500), which are colored accordingly, reflect varying color information depending on the terrain pattern. Therefore, as shown in FIG. 10, multiple secondary patterns (500), each with a different camouflage color corresponding to different terrain patterns, can be obtained.

At this point, the coloring of the secondary patterns (500) may be performed by matching camouflage colors that have a relatively high frequency of appearance in the pixel distribution of the dot image to primary patterns (400) having relatively smaller areas. For example, the camouflage color with the highest frequency may be applied to the smallest primary pattern, while the camouflage color with the lowest frequency may be applied to the largest primary pattern. By inversely matching the area of the pattern and the frequency ratio of the camouflage color in this manner, it is possible to achieve a camouflage pattern (see FIG. 11: 600) with an overall balanced color scheme. The coloring method can be changed as needed, and therefore, should not be interpreted in a limiting sense.

FIG. 11 is an example of a camouflage pattern generated by combining multiple secondary patterns and background colors.

As shown in FIG. 11, the colored secondary patterns (500) thus generated may be superimposed on a background color (501). Since the secondary patterns (500) vary in area, region, and shape due to terrain changes caused by elevation and slope, their superposition on the background color (501) results in an organically combined arrangement of camouflage colors and patterns that harmoniously fills the background without any pattern being excessively disrupted. The background color (501) may be selected from among the camouflage colors to fill the gaps that may remain after all the secondary patterns (500) are superimposed. The camouflage pattern (600) may also be formed in a way that reveals the dot pattern, utilizing the previously described mosaic effect, and the transparency of the background color (501) may be adjusted as necessary.

The resulting camouflage pattern (600), as described above, is based on surface analysis images of operational areas, such as satellite or aerial photographs. Therefore, it reflects the vegetation, seasons, geographic location (e.g., latitude), and terrain information including elevation and slope of the respective area. Furthermore, since terrain-characterizing patterns and camouflage colors that compress major color information are organically combined and overlaid, the specific features of the target area (operational region) are highly effectively represented, making visual detection in the corresponding area extremely difficult. This enables significantly improved camouflage and concealment effectiveness during operations.

It is highly preferable that such camouflage pattern (600) be formed with a specific pixel size (or resolution) in order to maximize camouflage and concealment effects. Preferably, the camouflage pattern (600) may have a resolution of at least 50 pixels per inch but less than 100 pixels per inch. More preferably, it may be formed with a resolution of 72 pixels per inch (72 dpi). For example, during one or more of the above-described steps (e.g., the primary pattern generation step), the number of pixels per inch may be adjusted to form the camouflage pattern (600) at the specified resolution. When the camouflage pattern (600) is formed at such a resolution, which corresponds to the highest readability standard for typical text fonts, its camouflage and concealment effects can be maximized. If the resolution exceeds or falls below this range, the functionality of the camouflage pattern may decrease, and thus it is highly preferable to form the camouflage pattern (600) within this resolution range.

FIG. 12 is an example showing the application of the camouflage pattern and an anti-counterfeit pattern to a military suit.

Referring to FIG. 12, the generated camouflage pattern (600) may be applied to a military suit after it is created. That is, during the manufacturing of the suit, the generated camouflage pattern (600) may be printed and/or dyed onto at least a portion of the upper and/or lower garments. This can significantly enhance the camouflage and concealment effects of individual soldiers wearing the suit. As previously described, such camouflage pattern is not limited to military suits, but may also be applied to other military equipment that requires camouflage and concealment. Therefore, it may be applied across a broad range of military goods and/or in related fields requiring similar camouflage and concealment effects, as previously mentioned. Accordingly, the present invention offers a high degree of versatility.

If necessary, after the camouflage pattern (600) is generated, an encrypted anti-counterfeit pattern (610) may be additionally applied by superimposing it over the camouflage pattern (600), as illustrated in FIG. 12. The anti-counterfeit pattern (610) can be generated with an adjusted size at a suitable location so that it can be applied without damaging the camouflage pattern (600). The anti-counterfeit pattern (610) may be applied for the purpose of protecting the manufacturer and may be formed as an encrypted pattern that is difficult for other manufacturers to recognize. Such a pattern may be implemented in various forms, such as a watermark (e.g., Braille, dot expression), and therefore is not limited to the illustrated drawings.

Through the above-described steps, a camouflage pattern (600) can be formed that enables highly effective camouflage and concealment in the target area (anticipated operational area), and it can be applied to military suits or various other military equipment.

Although the embodiments of the present invention have been described above with reference to the accompanying drawings, those skilled in the art to which the present invention pertains will understand that the present invention can be implemented in other specific forms without altering its technical spirit or essential features. Therefore, the embodiments described above are to be understood as illustrative in all respects and not as restrictive.

What is claimed is:

1. A military suit camouflage pattern forming method comprising:
(a) extracting, from a database storing satellite images of the surface of the earth, zonal and seasonal color images captured from above a target area where military operations are expected, and generating a sample image of the ground surface of the target area from the color images;
(b) generating a dot image by mapping all pixels of the sample image to a smaller number of pixels than the original, and extracting different camouflage colors from the pixels of the dot image;
(c) by reclassifying the sample image based on the elevation and slope of the ground surface and converting it to grayscale, extracting different terrain patterns based on the elevation and slope, as primary patterns; and
(d) coloring the primary patterns with the camouflage colors to generate secondary patterns whose colors vary according to the terrain patterns, and superimposing a plurality of the secondary patterns over a background color to generate a camouflage pattern.

2. The method of claim 1, wherein in step (b), the camouflage colors are extracted in descending order of frequency from among the colors that are repeatedly represented in the pixels of the dot image.

3. The method of claim 2, wherein in step (c), the primary patterns are extracted as grayscale images in the same number as the camouflage colors extracted in step (b).

4. The method of claim 3, wherein in step (c), the primary patterns are extracted by performing a highlighting process to amplify the contrast of the terrain patterns after the grayscale conversion.

5. The method of claim 4, wherein at least some of the terrain patterns in step (c) are selected to include fractal patterns having self-similarity in at least a portion of both the whole and the details.

6. The method of claim 4, wherein the primary patterns in step (c) have different areas corresponding to the elevation and slope of the ground surface in proportion to the size of the shading that varies depending on the terrain pattern.

7. The method of claim 6, wherein in step (d), the coloring is performed by matching the camouflage colors, which have relatively high proportions of appearance in the pixels of the dot image, to the primary patterns having relatively smaller areas.

8. The method of claim 1, wherein in step (a), the seasonal color images are extracted excluding winter images of the target area.

9. The method of claim 1, further comprising a step of adding an encrypted anti-counterfeit pattern superimposed on the camouflage pattern after step (d).

10. The method of claim 1, wherein the camouflage pattern has a resolution of at least 50 pixels per inch and less than 100 pixels per inch.
